(19) United States
(12) Patent Application Publication
(10) Pub. No.: US 2011/0206137 A1
(43) Pub. Date: Aug. 25, 2011

(54) WATERMARKED BASED PHYSICAL LAYER AUTHENTICATION METHOD OF TRANSMITTERS IN OFD COMMUNICATIONS SYSTEMS

(75) Inventor: Alessio Filippi, Eindhoven (NL)

(73) Assignee: KONINKLIJKE PHILIPS ELECTRONICS N.V., EINDHOVEN (NL)

(21) Appl. No.: 12/919,021

(22) PCT Filed: Feb. 27, 2009
(86) PCT No.: PCT/IB09/50805

§ 371 Date: Aug. 24, 2010

(30) Foreign Application Priority Data
Mar. 4, 2008 (EP) 08152237.7

(51) Int. Cl. H04N 7/24

(52) U.S. Cl. 375/240.26

(57) ABSTRACT

DVB-T2 is the next generation standard for the terrestrial digital broadcast. There is the request of identifying the transmitters in the Single Frequency Networks mainly for testing purposes. This might be achieved by embedding a watermark sequence in the transmitters to identify them uniquely. However, the transmitters can also be deployed in SFN so they have to transmit exactly the same data. Therefore, the watermark has to be added at the radio signal. It connot be added at content level as it happens in other standard as, for instance, in cellular systems. The invention proposes two possible new methods to watermark the transmitter ID in the DVB-T2 signal. In both cases we assign orthogonal pilot sequences to different transmitters. In one case the sequences are added at very low power to ensure no loss in the data rate. This is a very attractive alternative, but it might require a much more expensive receiver. In the second case the sequences are added in a specific set of sub-carriers reserved for this specific use. This requires a better receiver synchronization and it also generates a small loss in data rate, but ensure a very simple and robust way to provide the transmitter identification.

### FIELD OF THE INVENTION

The invention relates to a method of identifying transmitters, in particular to identifying transmitters in a single frequency network.

### BACKGROUND OF THE INVENTION

DVB-T2 is the next generation standard for the terrestrial digital television broadcast. There is a request of identifying the transmitters in single frequency networks, mainly for testing purposes, professional applications, and for applications in the consumer market.

Single frequency networks are characterized by a plurality of transmitters which are designed to synchronously transmit identical signals. The utilization of plural transmitters for sending a single data stream may provide improved broadcasting efficiency and reliability.

Since the transmitted signals need to be identical it is not possible to use scrambling codes to identify the different transmitters as done, for instance, in the Universal Mobile Telecommunications System (UMTS) standard. The use of scrambling codes would change the signal transmitted by each transmitter so that the required condition of identical signals in a single frequency network is not satisfied. Accordingly, it is an object to find a method for enabling identification of transmitters in a single frequency network.

### SUMMARY OF THE INVENTION

Identifying transmitters might be achieved by embedding a watermark sequence in the transmitters to identify them uniquely. However, if transmitters are employed in a Single Frequency Network (SFN), they have to transmit exactly the same data. In that case, the watermark cannot be added at content level as is done in other standards such as, for instance, cellular systems or UMTS standard systems. Therefore, the watermark could be added at the radio signal, i.e. at the radio frequency level.

Watermarking is a way of identifying the source of a signal. It is, inter alia, used in audio and video production to track the origin of illegal copies. The common approach consists of hiding a mark without degrading the original object. By recovering the mark, it is then possible to identify the object uniquely.

In wireless communication, watermarking might be used to identify the source of the signal, i.e. the antenna from which the signal is received. In most of the current wireless systems the receivers are locked to a single source, so the identification of the transmitter is done by acting at the content level, e.g. by identifying a given scrambling sequence used to scramble, i.e. reordering, the data bit mapped to the transmitted signal. For instance, each transmitter scrambles the bit sequence in a pseudo-random way so that the frame structure is reconstructed and recognized as a valid frame only if the correct and unique scrambling sequence is used at the receiver.

To the inventor's knowledge, prior art watermarking techniques do not address the problem of identifying multiple sources all contributing to the generation of a single final signal. This is the case for single frequency networks (SFN) where the received signal is made of the sum of all identical and simultaneously transmitted signals. If the watermark is used to identify the different transmitters contributing to the same signal, it cannot be applied in a straightforward way at the content level because this would cause the generation of different sequences from different sources, for example due to the randomized scrambling of the bit sequence. The transmission of different sequences in a single frequency network would make detection of the transmitted information extremely difficult. Therefore, the watermark has to be added at the radio frequency level.

There might be different ways of watermarking the signal at the radio frequency level.

The invention consists of defining a watermark signal capable of providing the transmitter identification in SFN, especially for DVB-T2.

An essential feature of the watermark sequence is the fact that the sequence is designed to perform an energy detection of the wireless channel between each single transmitter and the receiver. Somehow the watermark sequences are a form of distributed pilots designed to work as a watermark sequence.

Thus, it may be seen as an object of the present invention to enable identification of transmitters in a single frequency network where multiple transmitters contribute to the generation of a final signal.

This object and several other objects are obtained in a first aspect of the invention by providing a method of identifying transmitters where the transmitters are arranged in a network comprising a plurality of transmitters, the method comprising:

embedding one or more watermark symbols in a first transmitter,

embedding one or more watermark symbols in a second transmitter, so that the one or more watermark symbols are distributed over time positions and/or sub-carriers being uniquely associated to the individual transmitters.

In this context a watermark may be understood as a transmitter identification signature, i.e. a means for identifying a given transmitter in a network.

It is understood that the transmitters may transmit the watermark on one or more sub-carriers, but the transmitters may not necessarily transmit the data signal on sub-carriers although the watermark and the data signal are transmitted as a combined signal.

Thus, according to the first aspect the watermark sequence is embedded in the transmitted signal so that identification of individual transmitters contributing to the received signal is possible, for example by determining watermark content or watermark energies of the received signal by detecting watermark content or energies in the uniquely associated time slots and/or sub-carriers.

It may be seen as an advantage that different methods may be used for embedding the watermark so that identification of individual transmitters in a single frequency network is possible. Thus, embedding methods may be used where the watermark is distributed over sub-carriers using frequency multiplexing, is distributed over time positions or time cells using time multiplexing or is distributed both over sub-carriers and time cells using both time multiplexing and frequency multiplexing.

In an embodiment the transmitters are arranged to transmit a data signal and the watermark symbols on sub-carriers. Thus, the data signal may be multiplexed on sub-carriers which may be common with or distinct from the sub-carriers used for the watermark symbols.

In an embodiment the watermark symbols in the first transmitter is separated in time and/or sub-carrier frequency from the watermark symbols in the second transmitter. Using separate sets of time cells or sub-carriers for different transmitters may be seen as an advantageous way of enabling identification of transmitters by enabling the receiver to detect watermark content in the separate sets of time cells or sub-carriers.

In an embodiment the watermark symbol comprises an OFDM symbol with N_{W} sub-carriers. Thus, the watermark symbols in a given transmitter may be distributed over N_{W} sub-carriers.

In an embodiment each transmitter transmits the watermark symbols together with a data signal as identical signals contributing to the generation of a single final signal. Thus, the watermark symbols may combine with or add with the data signal to form a single receivable signal which contributes to a single final signal in the receiver together with other receivable signals.

In an embodiment, the first aspect further comprises:

receiving, in a receiver, embedded watermark symbols from the individual first and second transmitters,

determining an energy of watermark symbols in time positions and/or sub-carriers being uniquely associated with the individual transmitters. It may be seen as an advantage that the watermark content or watermark energy is determined by considering specific time positions/cells, sub-carries, or a combination thereof, uniquely associated with individual transmitters, since this allows identification of transmitters in a SFN network.

In an embodiment the energy of watermark symbols is determined by determining a sum of square values of averaged watermark symbols. It is understood that the watermark content in time positions or subcarriers may be quantified for identification of transmitters using other methods than determining watermark energy. Furthermore, watermark energy may be determined using other methods than by determining a sum of square values of averaged watermark symbols. Averaging of watermark content may be seen as a method for improving detection of embedded watermarks, e.g. by increasing the signal-to-noise ratio. Thus, averaging over sub-carriers and, in particular over time positions/cells, may not be required but may be seen as an improvement.

In an embodiment the one or more watermark symbols makes up a watermark sequence and the sign of the watermark sequence (WM) is changed for each frame. One or more watermark symbols may advantageously be used for a watermark sequence having the extent of a single frame. Thus, in one embodiment a single watermark symbol makes up the watermark sequence, i.e. the single watermark symbol has the extent of a single frame. In another embodiment, the watermark symbol is repeated to make up the watermark sequence. It may be seen as an advantage to change the sign of each watermark sequence since this may provide a convenient way of extracting the watermark sequence in the receiver.

In an embodiment the watermark symbols are transmitted together with the data signal and the watermark symbols are transmitted at a lower power than the data signal. It may be seen as an advantage to transmit the watermark symbol at a lower power than the data signal in order not to interfere with the data signal. Transmitting the watermark symbols at a lower power than the data signal may be particularly advantageously in combination with embodiments of embedding the watermark in distinct time positions or sub-carries, since such embedding schemes enables accurate detection of even weak watermark signals, e.g. by performing an average over multiple frames.

In an embodiment separate sets of distinct sub-carriers are associated with different transmitters. Accordingly, a first plurality of sub-carries may be associated with a first transmitter and a second plurality of sub-carries may be associated with a second transmitter.

In an embodiment, at least one sub-carrier is allocated to watermark symbols of different transmitters, and the watermark symbols are multiplexed over time positions being uniquely associated with separate transmitters. Thus, multiplexing the watermark symbols over time positions in one or more sub-carriers may provide an advantageous embodiment in particular when the sub-carriers are reserved for watermarks.

A second aspect of the invention relates to a transmitter arranged to carry out the method according to the first aspect. The transmitter may be provided with electronic processing means comprising computers, digital processors and electronic storage devices for distributing the watermark over time positions and/or sub-carriers associated with the transmitter. The transmitter may also be provided with radio frequency broadcasting electronics for transmitting the watermark and data signals.

A third aspect of the invention relates to a transmission system comprising a plurality of transmitters as defined in the second aspect of the invention. The plurality of transmitters may be provided with communication means for synchronizing signal transmission between transmitters.

A fourth aspect of the invention relates to a receiver comprising processing means for determining an energy of the watermark symbols in time positions and/or sub-carriers being uniquely associated with the individual transmitters. The receiver may also comprise an antenna for receiving embedded watermark symbols from a plurality of individual transmitters.

A fifth aspect of the invention relates to single frequency network comprising a transmission system according to the third aspect and a receiver according to the fourth aspect.

The first, second, third, fourth and fifth aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained, by way of example only, with reference to the accompanying Figures, where

FIG. 1 shows a watermark sequence made by the repetition of watermark symbols and data signal contained in the payload,

FIG. 2 shows a watermark signal in the form of pilots distributed over sub-carriers,

FIG. 3 shows energy content in watermarks associated with fifteen different transmitters,

FIG. 4 shows embedding of watermarks using time multiplexing,

FIG. 5 shows a single frequency network comprising a plurality of transmitters and a receiver,

FIG. 6 shows a flowchart diagram of a method according to the invention,

FIG. 7 shows a flowchart diagram of a method according to the invention using frequency multiplexing of a watermark.

### DESCRIPTION OF PREFERRED EMBODIMENTS

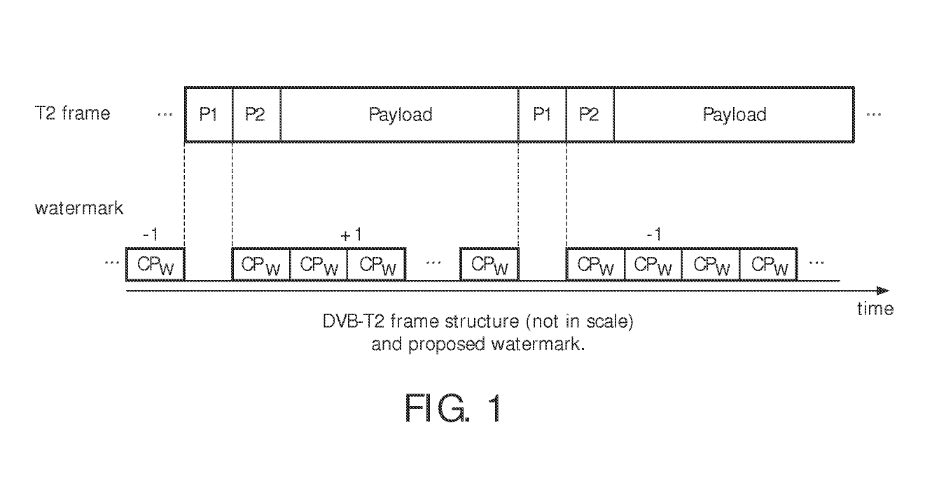

DVB-T2 is a digital video broadcast standard currently under development. The current draft version of the standard defines a frame structure which is roughly indicated in FIG. 1 together with the first embodiment of the invention. The DVB-T2 frame 112 will be of about 200 ms of duration and it will be made of a preamble part and a payload part. The preamble is organized in two special symbols: The P1 and the P2 symbol. The P1 is meant to provide very robust signal discovery also in very adverse conditions, to provide an initial time and frequency synchronization, and to signal 7 bit of signaling information about the structure of the following frame. The P2 is meant to provide finer channel synchronization, channel estimation and convey the signaling required to decode the payload part.

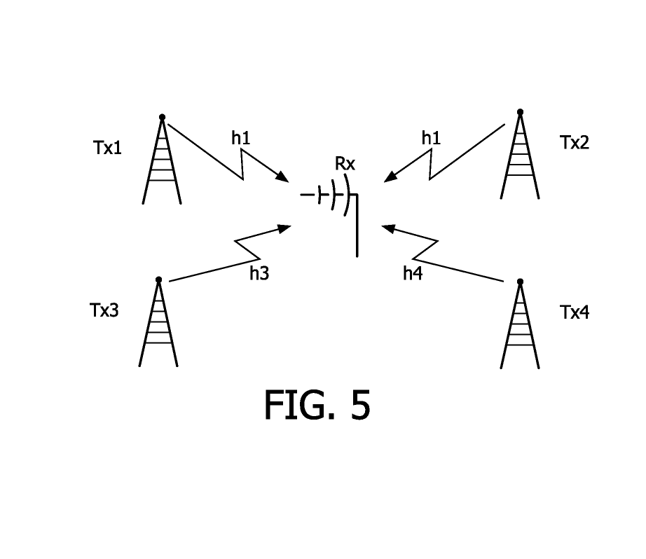

FIG. 5 shows a single frequency network comprising a plurality of transmitters Tx1-Tx4 which transmits identical signals or information sequences. The identical signals experience different wireless channels h1-h4 and are then received by receiver Rx. The (or at least some of the) received signals contribute to generate a single signal such as a digital television signal, usually comprising a multiplex of television programs.

The scope of this invention is to provide a robust method to signal which transmitters in the networks are contributing to the received signal. In this way, the network operator can investigate and improve the network planning/performance. In the following we propose two possible embodiments of the invention.

### Embodiment 1

The first embodiment describes a possible way to embed a watermark sequence in an SFN network deploying DVB-T2. In FIG. 1 we show the watermark sequence 113 made by the repetition of a CP_{W} (Continuous Pilot WaterMark) sequence 111. The CP_{W} sequence is made of an OFDM symbol.

Consequently, the CP_{W} sequence 111 is equivalently referred to as an OFDM symbol, a pilot symbol or a watermark symbol 111.

The OFDM symbols are characterized in that the sub-carriers are orthogonal.

The repetitions are always the same but their sign is changed frame by frame 112. The watermark sequence 113 in each odd frame 112 is multiplied by +1 and the watermark sequence 113 in each even frame 112 is multiplied by −1 (or vice versa). By doing so, the receiver can simply average the watermark on a frame by frame basis and then, when combining the average done over two consecutive frames, the deterministic interference component can be removed. The deterministic component comes from the presence of pilots (described below) within the T2 frame 114 which do not have zero average.

Clearly, the watermark sequence 113 can be generated differently than by repetition of an OFDM watermark symbol 111. For example the watermark sequence 113 may be generated as a single sequence which is repeated for each frame 112 with alternating signs. In this case the summation of watermark sequences 113 is replaced by the single watermark sequence. When the watermark sequence 113 is generated as a single sequence, the watermark symbol 111 is equivalent to a watermark sequence.

Each CP_{W} sequence 111 is made of an OFDM symbol 111 with N_{W} sub-carriers.

An OFDM symbol is made according to the Orthogonal Frequency-Division Multiplexing multi-carrier modulation technique. In the OFDM scheme, N complex symbols are transmitted in parallel so that each complex symbol modulates a single sub-carrier within the available bandwidth. The OFDM transmitter efficiently modulates all the N sub-carriers through an N-point discrete Fourier transform (DFT) efficiently implemented via a Fourier transform (FFT) algorithm. The output of the DFT consists of N samples which are referred to as an OFDM symbol.

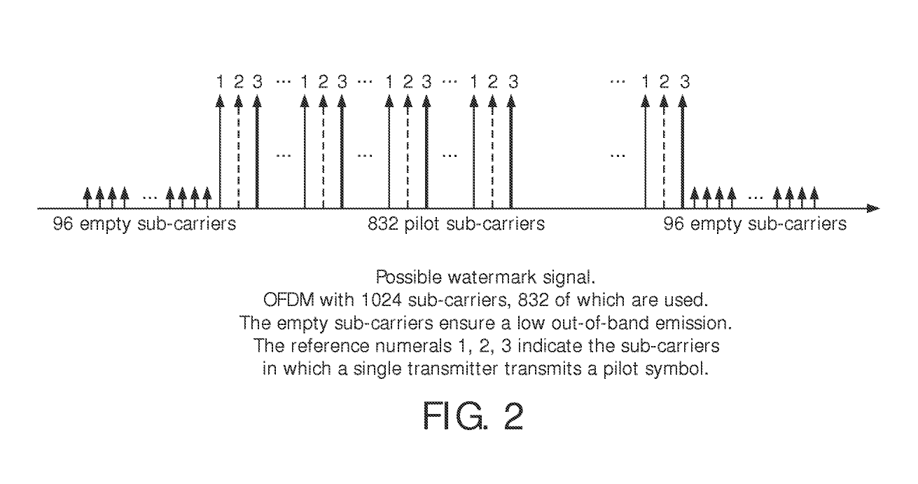

The number of sub-carriers can change depending on how many transmitters we want to watermark. The CP_{W} is designed to be an OFDM symbol so that it does not require any further time synchronization than that provided by the P1 symbol. Since the OFDM symbols are repeated over and over again, there is no need of inserting any guard interval because the previous OFDM symbol actually acts as a guard interval for the following OFDM symbol. A possible watermark signal is depicted in FIG. 2.

FIG. 2 shows a pilot symbol 211 as a function of sub-carrier frequencies along the horizontal axis. A pilot symbol 211 or repetitions of the pilot symbol 211 makes up a single watermark sequence 113. Thus, the pilot sequence 211 as shown in FIG. 2 is constituted by 1024 sub-carriers. Here the first and last 96 sub-carriers are empty sub-carriers meaning that no information is transmitted in these edge sub-carriers. The remaining 832 sub-carriers are divided by a number of transmitters, for example three transmitters Tx1-Tx3 which transmits in sub-carriers 1,2 and 3, respectively. For example, if transmitter Tx1 is active, Tx1 will transmit in sub-carriers 1 assigned to Tx1. Tx2 may not be active and, therefore, Tx2 will not transmit anything in sub-carriers 2 assigned to Tx2. In this way detection of which transmitters contributes to a final signal in a SFN network may be achieved by determining the energy in each sub-carrier in the received signal.

Transmission of a single pilot 212 in any one of the 832 sub-carriers may be constituted by a change in amplitude or phase of the carrier frequency in a given sub-carrier.

Other watermark signals using the same principle might use longer OFDM symbols, e.g. 2 k, 4 k, 8 k, or more sub-carriers and a larger number of possible transmitters. Thus, a 4 k OFDM watermark symbol 111 contains a pilot sequence of 4096 sub-carriers. The watermark sequence is transmitted together with the signal but at significant lower power level so that it does not interfere with the data signal. The sequence might have a power 40 dB below the transmitted power of the data. For example, transmitter Tx1 will transmit pilot sequence number sub-carriers indicated “1” in FIG. 2 and zeros in all the other sub-carriers.

A possible receiver might detect the CP_{W} by synchronizing with the P1 symbol and then calculate the average CP_{W} (avg) by summing up the consecutive CP_{W} symbols in order to extract the CP_{W} signal. The averaging should be done over an even number of frames to remove the deterministic component of the signal, i.e. the data signal which comprises the random information signal (e.g. a TV signal) and the deterministic component which is a pilot signal. The receiver does not need to be synchronized at the frame level, i.e. it does not need to know in which frame the CP_{W} have been multiplied by +1 or −1. The receiver only needs to combine the averaged CP_{W} in each frame by inverting the sign of one of the averaged CP_{W}. In this way, it ensures that the deterministic component is removed. The receiver estimates the energy by averaging the absolute square value of the signal received in the sub-carrier set assigned to each transmitter, and therefore the +1 or −1 sign becomes irrelevant. The receiver calculates an estimate of the energy of each possible propagation channel (i.e. communication channel h1 between a transmitter Tx1 and the receiver Rx), by looking at the received signal in each of the sub-carrier sets. Then a threshold detector can decide if a channel is present or not.

As an example, an average avg of the watermark over two or more consecutive frames may be performed for example by calculating

$$avg = \frac{1}{KL} {\sum }_{k = 0}^{K - 1} {( - 1 )}^{k} {\sum }_{l = 0}^{L - 1} {CP}_{W} ( k , l ) \qquad Eq . 1$$

where a number of L CP_{W} symbols 111 are averaged or summed on a frame basis and where the averages of K frames are combined by forming a sum over the K averages multiplied with alternating signs.

Eq. 1 shows only averaging of the watermark signal. However, it is understood that averaging is performed on the combined watermark and data signal. The averaging of the data signal includes averaging the random information signal and the deterministic component. Averaging of the random information signal approaches zero and averaging of the deterministic component will also equal zero since +/− signs are alternatively applied to the deterministic components for each frame according to Eq. 1. Accordingly, since averaging of the data signal approaches zero, the data signal is not included in Eq. 1 for convenience. Thus, the data signal could have been added to the CP_{W} signal in Eq. 1 in order to express the actual averaging of the combined watermark and data signal.

Equivalently, it may be understood that the sum of CP_{W} symbols 111 in Eq. 1 can be a sum of symbols containing both the watermark symbol CP_{W} and the data.

The watermark symbol CP_{W} may be seen as a sequence or vector of values of the sub-carriers, e.g. a vector of 1024 sub-carriers. Accordingly, also the average avg will be a sequence or vector with a dimension equal to the dimension of the watermark symbols.

The average avg gives the deterministic non-random averaged watermark symbol that was inserted in the DVB-T2 frames 112 of the transmitters Tx1-Tx4.

In order to determine if a given transmitter TX1 transmits a signal, the energy signal content in sub-carriers assigned to transmitter TX1 is determined, for example by calculating the sum of squares of the averaged avg-values assigned to transmitter TX1. Similarly, the energy in sub-carriers assigned to transmitter TX2 can be determined to verify if transmitter TX2 is transmitting.

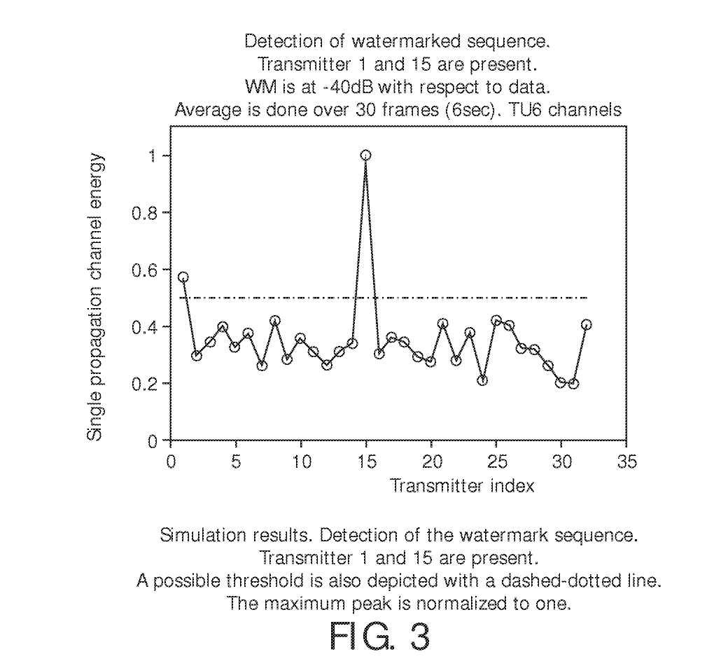

We have tested this method in a matlab simulation. We have generated a DVB-T2 like signal with P1, P2 and a payload part with OFDM symbol with 8 k sub-carriers. We have then added the WM sequence as depicted in FIG. 1 and simulated the presence of two transmitters. The receiver sees the two transmitted signals corrupted by two independent channels each made of two independent TU6 channels with a fixed relative delay between them. The CP_{W} are set to be 40 dB below the signal level. In FIG. 3 we show the simulation results obtained with a constant channel and an average over 30 frames, i.e. approximately 6 s. It is clear that by further averaging, the noise will be reduced further and further. The receiver has the possibility to trade-off the averaging time and detection quality. In FIG. 3, we considered the presence of 2 transmitters, i.e. transmitter 1 and 15. We can clearly see the two peaks and the noise floor which corresponds to the other CP_{W} which are assigned to no transmitter. Thus, the result in FIG. 3 is determined by calculating the energy content in sub-carriers assigned to each of a transmitter 1-15.

Based on the simulation results we can infer that the method is robust. It also gives room for more advanced receiver techniques. For instance, if the data signal is decoded correctly, it is possible to remove it from the received signal, thus leaving only noise and CP_{W}. The CP_{W} can be then detected with a much higher precision. This has been also tested and confirmed by simulation.

### Embodiment 2

In an embodiment of the invention, we still watermark the presence of the transmitters in the DVB-T2 SFN, by basically assigning orthogonal pilot sequences to the transmitter, but we use a very different approach which consists of multiplexing, i.e. time or frequency multiplexing, the WM sequences with the DVB-T2 signal in the OFDM domain. To detect the WM sequence, we then need to decode the data or at least to synchronize with the OFDM symbols. The idea is to reserve a very limited number of sub-carriers to allocate the pilots of different transmitters. In a general sense we reserve N_{txid} OFDM cells 411 per frame 412. The exact number of N_{txid} will depend on the desired accuracy, the desired maximum number of transmitters and the loss in data cells. These cells should also interfere as less as possible with the frame structure and the data and also provide a method to separate the transmitters easily.

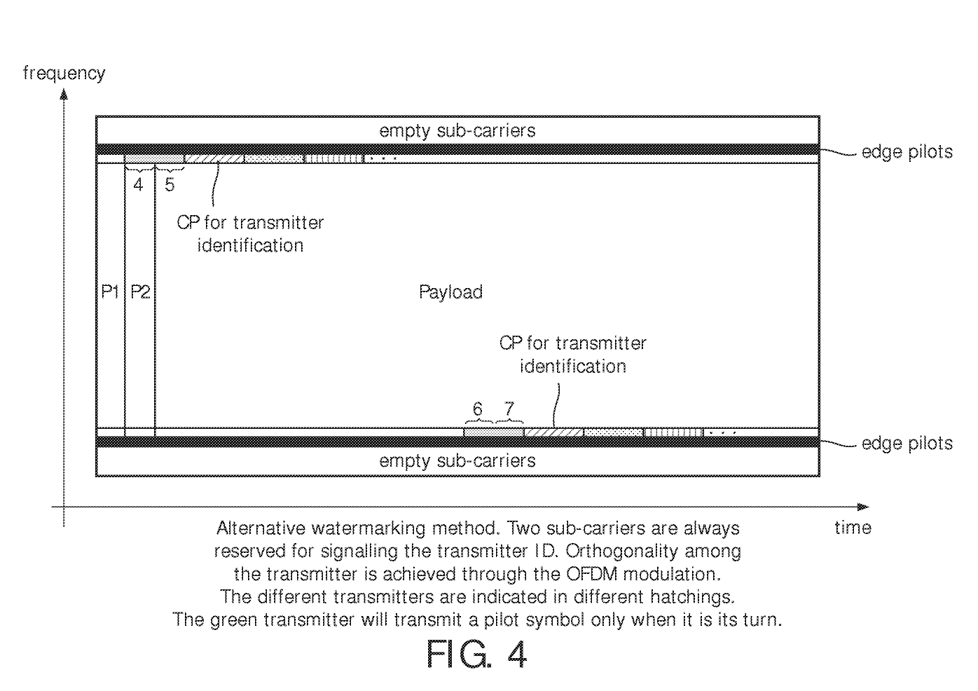

A possible solution could be to reserve the first and last non-pilot sub-carriers—i.e. sub-carriers that are not modulated by the deterministic data pilots of the data signal—in all the OFDM symbols for indicating the transmitter identity as depicted in FIG. 4.

The orthogonality between the watermark and the data is achieved in the OFDM domain. Each transmitter transmits two pilot symbols in the signaling sub-carriers in the OFDM symbols assigned to it. In FIG. 4, transmitter 3 transmits a pilot symbol 4 in the P2 symbol and then a next one 5 in the following OFDM symbol in the first reserved sub-carrier. Then it will not transmit anything more on that sub-carrier. If the frame is made of 200 OFDM symbols, and we have two cells per transmitter, with this method we can allocate 100 transmitters. In the next used sub-carrier, the same allocation might be used but cyclically rotated to maximize the distance of the pilots of the same transmitter (see FIG. 2). In FIG. 4, transmitter 3 transmits the pilot symbols 6 and 7 in the last reserved sub-carrier.

One or more pilot symbols 411 may be assigned to a given transmitter Tx1. An advantage of assigning two or more pilot symbols 411, for example two pilot symbols 3,4 as shown in FIG. 4, is that two pilot symbols 411 may be compared by the receiver Rx to detect a difference in the frequency spectrum of the received pilot or watermark symbols 411. A difference in the frequency spectrum of two watermark symbols may indicate a defect of a transmitter Tx1.

A transmitter may use only one cell 411 of each sub-carrier, or the transmitter may use two or more cells of each-subcarrier. The use of a plurality of cells 411 enables greater robustness in detection of WM sequences, and enables determination of differences between subsequent cells 411, for example for assessing a failure of a transmitter.

The receiver can then easily estimate the presence of transmitter 3 by looking at the received pilots in the respective cells and performing an energy estimation on those positions. Although not required, an averaging of the energies in cells assigned to different transmitters may be performed in order to improve the quality of the watermark detection. Averaging may for example be performed by calculating the sum of squares of watermark content in cells 411 assigned to transmitter 3 and other cells assigned to other transmitters. However, since in this embodiment the watermark and the data signals are orthogonal, the averaging operation is not required to extract the WM sequence.

The number of dedicated cells/sub-carriers can change and will determine the robustness of the method. The method can estimate the energy over multiple frames and improve the estimate by averaging the estimate over multiple frames.

Thus, in embodiment 2, the watermark symbols (CP_{W}, 111) are distributed over time positions 4,5,411 and distinct sub-carriers.

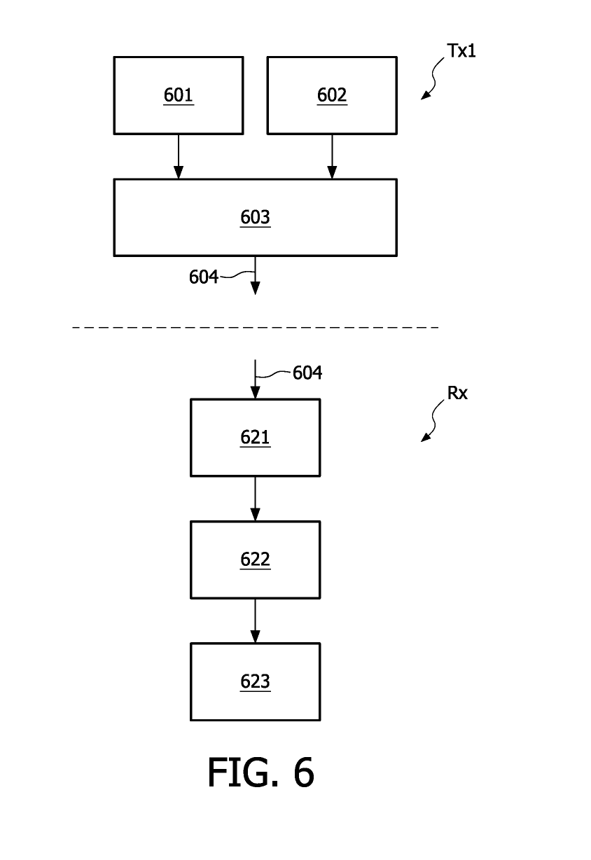

FIG. 6 shows a flowchart diagram according to the invention. In step 601a watermark sequence 113 or one or more watermark symbols 111 are provided, for example by a processor configured for generating watermark symbols 111 or from a storage (not shown) or from signaling from higher layers of the protocol stack (not shown). In step 602 data comprising the payload and the P1 and P2 symbols are provided, for example from data storage, a data receiver or a processor (not shown). In step 603 the watermark and the data are combined, for example by adding the watermark and the data into a single transmitted signal 604. The combining may be performed prior to transmitting the combined signal 604 via a transmitter, for example by an electronic summation circuit (not shown). Alternatively, the watermark and the data may be transmitted from separate antennas of a given transmitter in which case the watermark signal and the data signal combine, or rather add, in the air, into a single transmitted signal 604. Thus, the steps 601-603 may be embodied by a transmitter Tx1.

In step 621, the transmitted signal of one of the transmitters Tx1-Tx4 is received by an antenna (not shown) of a receiver. In step 622, the frames of the received signal is summed or averaged, e.g. by a processor (not shown) for extraction of the deterministic watermark symbols 111 and watermark sequences 113. In step 623, the energy content of sub-carries assigned to different transmitters is determined in order to determine which transmitter transmits data. Step 623 may be performed by a processor configured, for example to calculate the sum of squares of the averaged avg-values assigned to each transmitter Tx1-Tx4. Thus, the steps 621-623 may be embodied by a receiver Rx.

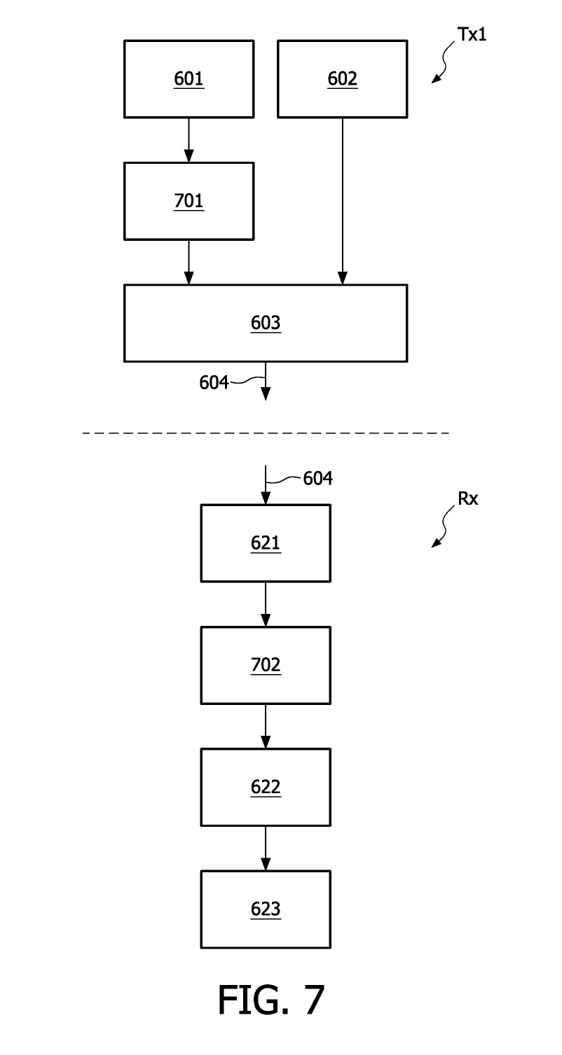

FIG. 7 shows a flowchart according to embodiment 1 of the invention. In comparison with FIG. 6, the flowchart in FIG. 7 comprises an additional step 701 of alternatively multiplying watermark sequences 113 with +1 and −1 to form watermark sequences with alternating signs. On the receiver side, in an additional step 702, frames of the received signal 604 are alternatively multiplied with +1 and −1 according to Eq. 1 in order to extract the pilot symbols 212 in a subsequent averaging step 622. Alternatively, watermark symbols 611 may be summed and subsequently the summed watermark symbols 611 may alternatively be multiplied with +1 and −1, still according to Eq. 1.

With respect to embodiment 2, combining the watermark with the data in step 603 comprises time or frequency multiplexing of watermark symbols 111, 411 according to different time cells 411 assigned to different transmitters. Frequency multiplexing in embodiment 2 refers to multiplexing over different subcarriers 413.

In embodiment 2, the steps 622 and 623 comprise determination of energy content in different time cells 411 assigned to different transmitters. Thus, in embodiment 2, pilot symbols 3,4,411 of one or more frames 412 are summed or averaged and the energy content of one or more time cells 411 associated with a given transmitter is determined.

The invention can be summarized as follows. DVB-T2 is the next generation standard for the terrestrial digital broadcast. There is the request of identifying the transmitters in the Single Frequency Networks mainly for testing purposes. This might be achieved by embedding a watermark sequence in the transmitters to identify them uniquely. However, the transmitters can also be deployed in SFN so they have to transmit exactly the same data. Therefore, the watermark has to be added at the radio signal. It cannot be added at content level as it happens in other standard as, for instance, in cellular or UMTS systems.

The invention proposes two possible new methods to watermark the transmitter ID in the DVB-T2 signal. In both cases we assign orthogonal pilot sequences to different transmitters. In one case the sequences are added at very low power to ensure no loss in the data rate. This is a very attractive alternative, but it might require a much more expensive receiver. In the second case the sequences are added in a specific set of sub-carriers reserved for this specific use. This requires a better receiver synchronization and it also generates a small loss in data rate, but ensure a very simple and robust way to provide the transmitter identification.

1. A method of identifying transmitters where the transmitters are arranged in a network comprising a plurality of transmitters, the method comprising:
embedding one or more watermark symbols (CP_{W}, 111, 411) in a first transmitter (Tx1),
embedding one or more watermark symbols (CP_{W}, 111, 411) in a second transmitter (Tx2), so that the one or more watermark symbols (CP_{W}, 111) are distributed over time positions (4,5,411) and/or one or more sub-carriers (1,2,3,413) being uniquely associated to the individual transmitters.

2. A method according to claim 1, where transmitters are arranged to transmit a data signal and the watermark symbols on sub-carriers (212).

3. A method according to claim 1, where the watermark symbols (CP_{W}, 111, 411) in the first transmitter is separated in time and/or sub-carrier frequency from the watermark symbols (CP_{W}, 111, 411) in the second transmitter.

4. A method according to claim 1, where the watermark symbol (CP_{W}, 111, 411) comprises an OFDM symbol with N_{W} sub-carriers.

5. A method according to claim 1, where each transmitter transmits the watermark symbols (CP_{W}, 111, 411) together with a data signal as identical signals contributing to the generation of a single final signal.

6. A method according to claim 1, further comprising:
receiving, in a receiver (Rx), embedded watermark symbols (CP_{W}, 111, 411) from the individual first and second transmitters,
determining an energy of watermark symbols in time positions (411) and/or sub-carriers (1,2,3) being uniquely associated with the individual transmitters.

7. A method according to claim 6, where the energy of watermark symbols (CP_{W}, 111, 411) is determined by determining a sum of square values of averaged watermark symbols (CP_{W}, 111).

8. A method according to claim 1, where the one or more watermark symbols (CP_{W}, 111) makes up a watermark sequence (WM) and where the sign of the watermark sequence (WM) is changed for each frame.

9. A method according to claim 8, where a watermark symbol (CP_{W}, 111) is repeated to make up the watermark sequence.

10. A method according to claim 1, where the watermark symbols (CP_{W}, 111, 411) are transmitted together with the data signal and where the watermark symbols (CP_{W}, 111) are transmitted at a lower power than the data signal.

11. A method according to claim 1, where separate sets of distinct sub-carriers (1,2,3) are associated with different transmitters (Tx1,Tx2,Tx3).

12. A method according to claim 1, where at least one sub-carrier (413) is allocated to watermark symbols (WM, 411) of different transmitters, and where the watermark symbols (CP_{W}, 111) are multiplexed over time positions (411) being uniquely associated with separate transmitters.

13. A transmitter (Tx1) arranged to carry out the method as claimed in claim 1.

14. A transmission system comprising a plurality of transmitters as defined in claim 13.

15. A receiver (Rx) comprising processing means for determining an energy of watermark symbols in time positions (411) and/or sub-carriers (1,2,3) being uniquely associated with individual transmitters.

16. A single frequency network (SFN) comprising a transmission system according to claim 14 and a receiver (Rx) comprising processing means for determining an energy of watermark symbols in time positions (411) and/or sub-carriers (1,2,3) being uniquely associated with individual transmitters.
